(19) United States
(12) Patent Application Publication
(10) Pub. No.: US 2023/0373129 A1
(43) Pub. Date: Nov. 23, 2023

(54) PEELING APPARATUS

(71) Applicant: DISCO CORPORATION, Tokyo (JP)

(72) Inventors: Koyo HONOKI, Tokyo (JP); Koji ITABASHI, Tokyo (JP); Ryohei YAMAMOTO, Tokyo (JP); Haruki MATSUO, Tokyo (JP)

(21) Appl. No.: 18/319,607

(22) Filed: May 18, 2023

(30) Foreign Application Priority Data
May 19, 2022 (JP) 2022-082111

(51) Int. Cl. B28D 5/04; B28D 5/00; B23K 26/00; B23K 26/08; B23K 26/40

(52) U.S. Cl. CPC B28D 5/047; B28D 5/0094; B28D 5/0064; B28D 5/0011; B28D 5/0052; B23K 26/0093; B23K 26/0853; B23K 26/40; B23K 2101/40

(57) ABSTRACT

A peeling apparatus includes a holding table that holds an ingot, a water supply unit that forms a layer of water on an upper surface of the ingot, an ultrasonic unit that applies an ultrasonic wave to the upper surface of the ingot through the layer of water, a peeling confirmation unit that confirms peeling-off of a wafer to be manufactured, a wafer delivery unit that lowers a suction pad having a suction surface facing the upper surface of the ingot, to hold the wafer to be manufactured on the suction surface under suction, and delivers the wafer from the ingot, and a controller. After the peeling-off of the wafer is confirmed by the peeling confirmation unit, the controller positions the water supply unit, the ultrasonic unit, and the peeling confirmation unit at retracted positions and operates the wafer delivery unit to deliver the wafer from the ingot.

### BACKGROUND OF THE INVENTION

### Field of the Invention

The present invention relates to a peeling apparatus for peeling off a wafer from an ingot having a peeling layer formed therein at a depth corresponding to the wafer to be manufactured.

### Description of the Related Art

Such devices as power devices and light emitting diodes (LEDs) are formed in respective areas of a functional layer laminated on a front surface of a wafer formed of single crystal SiC, the respective areas being demarcated by a plurality of intersecting projected dicing lines.

Wafers to be formed with the devices are generally manufactured by slicing an ingot with a wire saw and polishing and finishing front and back surfaces of the sliced wafers to mirror surfaces (refer to, for example, Japanese Patent Laid-open No. 2000-094221).

When the wafers are manufactured by slicing a single crystal SiC ingot with a wire saw and polishing the front and back surfaces of the sliced wafers, 70% to 80% of the ingot is discarded, which is uneconomical. Therefore, the present applicant has proposed a technology in which a laser beam of such a wavelength as to be transmitted through the single crystal SiC is applied to the ingot, with a focal point of the laser beam positioned inside the ingot, to form a peeling layer at a scheduled cutting plane, and the wafer is then peeled off from the ingot at the peeling layer (refer to Japanese Patent Laid-open No. 2016-111143).

According to the technology disclosed in Japanese Patent Laid-open No. 2016-111143, the problem of the uneconomical manufacturing process where 70% to 80% of the ingot is discarded is solved. However, since it is relatively difficult to peel off the wafer from the ingot at the peeling layer formed by application of the laser beam, it leaves a problem in terms of low productivity. In view of this, the present applicant has proposed a peeling apparatus for peeling off a wafer from an ingot by forming a layer of water on an upper surface of the ingot, which corresponds to an upper surface of the wafer to be manufactured, and applying an ultrasonic wave to the upper surface (refer to Japanese Patent Laid-open No. 2019-102513).

### SUMMARY OF THE INVENTION

According to the technology disclosed in Japanese Patent Laid-open No. 2019-102513, a wafer can efficiently be peeled off from an ingot, and the problem of poor productivity is thus solved. However, when the wafer is peeled off from the ingot by application of the ultrasonic wave to the upper surface of the ingot and is then delivered from the peeling apparatus while being held under suction, it is difficult to identify a peeling timing at which the wafer is completely peeled off from the ingot. If the wafer is to be delivered by being held under suction after the peeling timing has elapsed, the peeled wafer may fall off the upper surface of the ingot due to the flow of water, leading to damage to the wafer, for example.

Accordingly, it is an object of the present invention to provide a peeling apparatus capable of preventing a wafer from falling off an upper surface of an ingot and from being damaged when the wafer is peeled off from the ingot by application of an ultrasonic wave to the upper surface of the ingot and is then delivered from the peeling apparatus while being held under suction.

In accordance with an aspect of the present invention, there is provided a peeling apparatus for peeling off a wafer from an ingot having a peeling layer formed therein at a depth corresponding to the wafer to be manufactured. The peeling apparatus includes a holding table that holds the ingot, a water supply unit that forms a layer of water on an upper surface of the ingot, an ultrasonic unit that applies an ultrasonic wave to the upper surface of the ingot through the layer of water, a peeling confirmation unit that confirms peeling-off of the wafer to be manufactured, a wafer delivery unit that lowers a suction pad having a suction surface facing the upper surface of the ingot, to hold the wafer to be manufactured on the suction surface under suction, and delivers the wafer from the ingot, and a controller. After the peeling-off of the wafer is confirmed by the peeling confirmation unit, the controller positions the water supply unit, the ultrasonic unit, and the peeling confirmation unit at retracted positions and operates the wafer delivery unit to deliver the wafer from the ingot.

According to the peeling apparatus of the present invention, a timing at which the wafer to be manufactured is peeled off is appropriately detected by the peeling confirmation unit, whereby the wafer to be manufactured can securely be delivered from the ingot by the wafer delivery unit. This prevents the wafer from falling off the ingot and being damaged.

The above and other objects, features and advantages of the present invention and the manner of realizing them will become more apparent, and the invention itself will best be understood from a study of the following description and an appended claim with reference to the attached drawings showing a preferred embodiment of the invention.

### BRIEF DESCRIPTION OF THE DRAWINGS

FIG. 1A is a perspective view of an ingot to which a peeling apparatus according to an embodiment of the present invention is applied;

FIG. 1B is a side view of the ingot;

FIG. 2 is a perspective view depicting a manner in which a peeling layer forming step is performed on the ingot depicted in FIG. 1;

FIG. 3A is a plan view of the ingot in which a peeling layer is formed in the peeling layer forming step depicted in FIG. 2;

FIG. 3B is an enlarged cross-sectional view taken along a line A-A of FIG. 3A;

FIG. 4 is a perspective view of a peeling apparatus according to the embodiment of the present invention;

FIG. 5A is a perspective view depicting a state where a wafer to be manufactured is peeled off from the ingot by the peeling apparatus depicted in FIG. 4;

FIG. 5B is a side view depicting a manner in which an ultrasonic wave is applied to the ingot in the state depicted in FIG. 5A;

FIG. 6 is a perspective view depicting a manner in which a wafer delivery unit is brought close to the ingot; and

FIG. 7 is a perspective view depicting a state in which the wafer is delivered by the wafer delivery unit.

### DETAILED DESCRIPTION OF THE PREFERRED EMBODIMENT

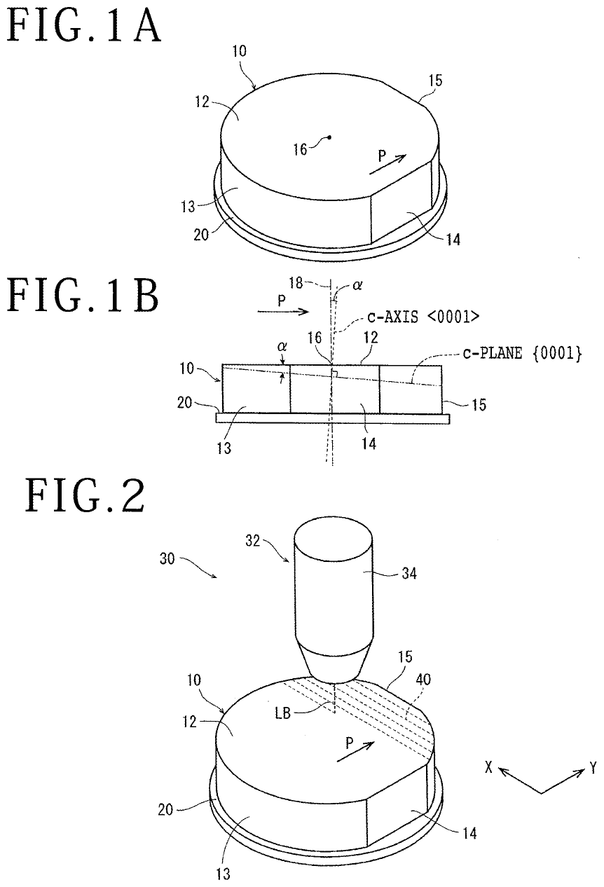

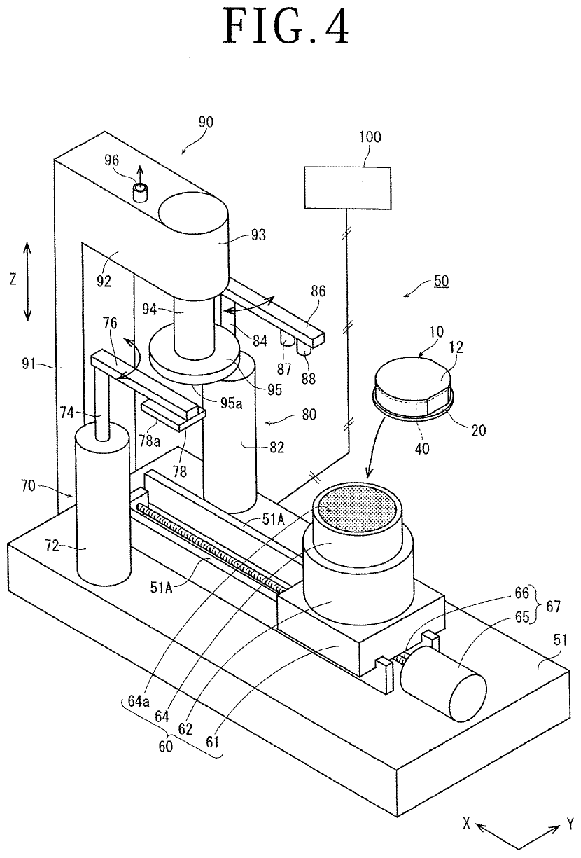

A peeling apparatus according to an embodiment of the present invention will be described in detail below with reference to the attached drawings. FIGS. 1A and 1B depict an ingot 10 from which a wafer to be manufactured is peeled off by a peeling apparatus 50 (see FIG. 4) described later, and in which a peeling layer (described later) is yet to be formed. The ingot 10 in the present embodiment is formed of hexagonal single crystal SiC and has a substantially cylindrical shape as a whole. Further, the ingot 10 includes a circular first end face 12, a circular second end face (not denoted by any reference sign) which is a face opposite to the first end face 12 and on which a substrate 20 is mounted, a circumferential surface 13 located between the first end face 12 and the second end face, a c-axis (<0001> direction) extending from the first end face 12 to the second end face, and a c-plane ({0001} plane) orthogonal to the c-axis. The c-axis is inclined relative to a perpendicular 18 (see FIG. 1B) passing through a center 16 of the first end face 12 of the ingot 10 depicted in FIG. 1A, and the c-plane and the first end face 12 form an off angle α (for example, α=1, 3, or 6 degrees) therebetween. The direction in which the off angle α is formed is indicated by an arrow P in FIGS. 1A and 1B.

In addition, the circumferential surface 13 of the ingot 10 is formed with a rectangular first orientation flat 14 and a rectangular second orientation flat 15 which indicate crystal orientations. The first orientation flat 14 is parallel to the direction P in which the off angle α is formed, whereas the second orientation flat 15 is orthogonal to the direction P in which the off angle α is formed. The length of the second orientation flat 15 is shorter than the length of the first orientation flat 14, whereby the front and back sides of the ingot 10 and the inclination direction of the off angle α are specified. Note that the ingot 10 from which the wafer is peeled off by the peeling apparatus 50 described later is not limited to the above-described ingot 10. For example, the ingot may be a single crystal SiC ingot in which the c-axis is not inclined relative to the perpendicular to the end face of the ingot and the off angle between the c-plane and the end face is 0 degrees (that is, the perpendicular to the end face and the c-axis coincide with each other), or may be an ingot formed of a material other than single crystal SiC, such as silicon (Si) or gallium nitride (GaN).

In order to peel off the wafer from the ingot 10 by the peeling apparatus 50 described later, it is necessary to form a peeling layer in the ingot 10. Formation of the peeling layer can be performed, for example, by use of a laser processing apparatus 30 depicted in FIG. 2 (only part of the laser processing apparatus 30 is depicted). The laser processing apparatus 30 includes an unillustrated chuck table that holds a workpiece and a laser beam applying unit 32 that includes a light concentrating unit 34 for applying a pulsed laser beam LB to the workpiece held on the chuck table. The chuck table is configured to hold the workpiece under suction on an upper surface thereof, and includes a rotational drive mechanism, an X-axis moving mechanism, and a Y-axis moving mechanism, which are omitted in illustration. The chuck table can move the ingot 10 held thereon relative to the light concentrating unit 34 and position the ingot 10 at any XY coordinate position. The light concentrating unit 34 includes a condenser lens (omitted in illustration) for concentrating the pulsed laser beam LB oscillated by a pulsed laser oscillator (omitted in illustration) of the laser processing apparatus 30 and applying the pulsed laser beam LB to the workpiece.

Continuously described with reference to FIG. 2, at the time of forming the peeling layer in the ingot 10, the ingot 10 is first held under suction on the upper surface of the chuck table while the first end face 12 of the ingot 10 is directed upward and the second end face side on which the substrate 20 is mounted is directed downward. Next, an imaging unit (omitted in illustration) of the laser processing apparatus 30 captures an image of the ingot 10 from above the ingot 10. Subsequently, the X-axis moving mechanism, the Y-axis moving mechanism, and the rotational drive mechanism of the laser processing apparatus 30 are operated to adjust the orientation of the ingot 10 to a predetermined direction and position the ingot 10 at a predetermined XY position on the basis of the image of the ingot 10 captured by the imaging unit. At the time of adjusting the orientation of the ingot 10 to the predetermined direction, as depicted in FIG. 2, the second orientation flat 15 is made to be coincident with the X-axis direction. As a result, the direction orthogonal to the direction P in which the off angle α is formed is matched to the X-axis direction, and the direction P in which the off angle α is formed is matched to the Y-axis direction.

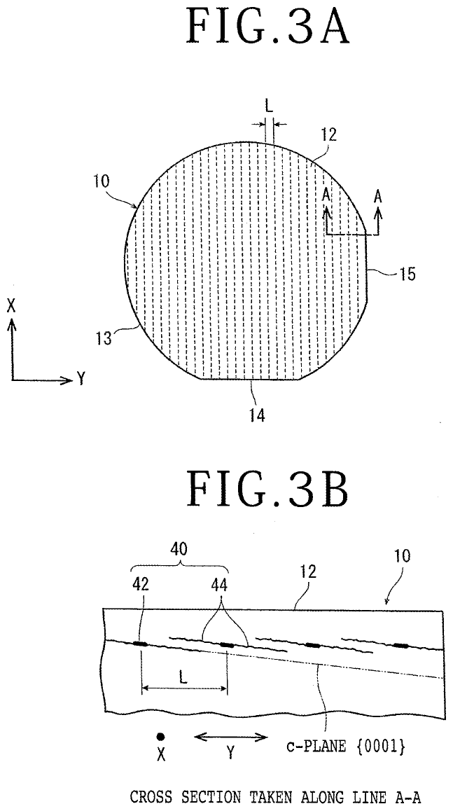

Next, the light concentrating unit 34 is lifted or lowered by a focal point position adjustor (omitted in illustration) of the laser processing apparatus 30 to position a focal point at a depth corresponding to the thickness of the wafer to be manufactured from the first end face 12 of the ingot 10. Subsequently, a peeling layer forming step is conducted. In the peeling layer forming step, a pulsed laser beam LB of such a wavelength as to be transmitted through the single crystal SiC is applied from the light concentrating unit 34 to the ingot 10, and the ingot 10 is moved in the X-axis direction matched to the direction orthogonal to the direction P in which the off angle α is formed, thereby forming a peeling layer 40. In the peeling layer forming step, as understood from FIGS. 3A and 3B, modified portions 42 are successively formed in the ingot 10 in the X-axis direction. In the modified portions 42, SiC is separated into Si and carbon (C) by application of the pulsed laser beam LB, and the pulsed laser beam LB applied next is absorbed in C previously formed, separating SiC into Si and C in a chain reaction manner. In addition, cracks 44 isotropically extending from the modified portion 42 along the c-plane are formed. After the modified portions 42 and the cracks 44 are thus formed, the ingot 10 is index-fed by a predetermined indexing amount L in the Y-axis direction, and the above-mentioned laser processing is repeated. As a result, the peeling layer 40 which includes a plurality of modified portions 42 and cracks 44 can be formed at a depth corresponding to the thickness of the wafer to be manufactured from the first end face 12 of the ingot 10. The peeling layer 40 is lowered in strength, so that the wafer is peeled off from the ingot 10 at the peeling layer 40.

Note that the above-described peeling layer forming step for forming the peeling layer 40 can be carried out, for example, under the following processing conditions.
Wavelength of pulsed laser beam: 1,064 nm
Repetition frequency: 60 kHz
Average output: 1.5 W
Pulse width: 4 ns
Spot diameter: 3 μm
Numerical aperture (NA) of condenser lens: 0.65
Processing feed speed: 200 mm/s

FIG. 4 depicts the peeling apparatus 50 according to the present embodiment that peels off the wafer from the ingot 10 formed with the above-described peeling layer 40.

The peeling apparatus 50 includes a holding unit 60 that holds the ingot 10, a water supply unit 88 that forms a layer of water on an upper surface of the ingot 10, an ultrasonic unit 78 that applies an ultrasonic wave to the upper surface of the ingot 10 through the layer of water, a peeling confirmation unit 87 that confirms peeling-off of the wafer to be manufactured, a wafer delivery unit 90 that lowers a suction pad 95 having a suction surface 95a facing the upper surface (the first end face 12) of the ingot 10, to hold the wafer to be manufactured on the suction pad 95 under suction, and that delivers the wafer from the ingot 10, and a controller 100.

The holding unit 60 includes a rectangular movable plate 61 mounted on a base 51 of the peeling apparatus 50 movably in the X-axis direction indicated by an arrow X in the figure, a cylindrical support column 62 fixed to an upper surface of the movable plate 61, and a holding table 64 that is disposed at an upper end of the support column 62 and that holds the above-mentioned ingot 10. The holding table 64 is rotatable by an unillustrated rotational drive mechanism. The holding table 64 has, at an upper surface thereof, a circular suction chuck 64a that is formed of a porous material and that extends substantially horizontally. The suction chuck 64a is connected to unillustrated suction means by a passage passing through the support column 62. The holding unit 60 also includes a moving mechanism 67 that moves the holding table 64 in the X-axis direction. The moving mechanism 67 converts a rotational motion of a motor 65 into a rectilinear motion and transmits the rectilinear motion to the movable plate 61 through a ball screw 66, to thereby cause the movable plate 61 to advance and retract in the X-axis direction along a pair of guide rails 51A disposed on the base 51 in parallel to the X-axis direction. Note that, though omitted in illustration, the holding unit 60 also includes position sensors that accurately detect the position of the holding table 64 in the X-axis direction and the rotational position in the circumferential direction, and the moving mechanism 67 and the rotational drive mechanism are driven according to signals given by the controller 100, whereby the holding table 64 can accurately be positioned at a desired position in the X-axis direction and at a desired rotational angle.

On a rear portion of the base 51 of the peeling apparatus 50 in the X-axis direction, a first positioning unit 70 and a second positioning unit 80 are disposed with the pair of guide rails 51A interposed therebetween. The first positioning unit 70 includes a cylinder 72, a lifting and lowering rod 74 that is lifted and lowered by the cylinder 72, and a swing arm 76 that is disposed at an upper end of the lifting and lowering rod 74 and that can be swung by the cylinder 72. At the tip of the swing arm 76, the ultrasonic unit 78 that applies an ultrasonic vibration from a lower surface 78a thereof to the ingot 10 positioned at a predetermined peeling position is disposed. The second positioning unit 80 includes a cylinder 82, a lifting and lowering rod 84 that is lifted and lowered by the cylinder 82, and a swing arm 86 that is disposed at an upper end of the lifting and lowering rod 84 and that can be swung by the cylinder 82. At the tip of the swing arm 86, the peeling confirmation unit 87 that confirms the peeling-off of the wafer to be manufactured from the ingot 10 positioned at the predetermined peeling position and the water supply unit 88 that forms a layer of water on the upper surface of the ingot 10 are disposed.

The ultrasonic unit 78, the peeling confirmation unit 87, and the water supply unit 88 are appropriately controlled by the controller 100. The ultrasonic unit 78 applies an ultrasonic frequency of 25 kHz at an output of 100 W, for example. The peeling confirmation unit 87 is means which includes, for example, what is called a proximity sensor and which detects a variation in a surface height of the first end face 12 of the ingot 10 positioned directly under the peeling confirmation unit 87 (the surface height varies when the first end face 12 floats up from the ingot 10 after the start of peeling). The proximity sensor included in the peeling confirmation unit 87 is not limited to a particular sensor. For example, the sensor may be an ultrasonic-type sensor that applies an ultrasonic wave to the ingot 10, detects the reflected wave, and detects the height position where the ultrasonic wave is applied, on the basis of the return time of the reflected wave, or may be a proximity sensor of other type such as an electromagnetic wave type sensor or an infrared ray type sensor. The water supply unit 88 is connected to an unillustrated water supply source through a vertical part 91 and a horizontal part 92 of the wafer delivery unit 90 and supplies water from a lower surface thereof, for example, at a rate of 3 L/min.

The wafer delivery unit 90 is disposed at a rear end portion of the peeling apparatus 50 in the X-axis direction. In other words, the moving mechanism 67 is disposed on one end side of the pair of guide rails 51A, and the wafer delivery unit 90 is disposed on the opposite end side of the pair of guide rails 51A. The wafer delivery unit 90 includes the vertical part 91 erected on the base 51, the horizontal part 92 that is disposed at an upper end of the vertical part 91 and that extends horizontally, a cylinder 93 disposed at an end portion of the horizontal part 92, a lifting and lowering rod 94 that is lifted and lowered by the cylinder 93, and the suction pad 95 that is disposed at a lower end of the lifting and lowering rod 94 and that has the suction surface 95a as a lower surface thereof. A suction port 96 for generating a negative pressure on the suction surface 95a of the suction pad 95 is formed in the horizontal part 92 and is connected to an unillustrated suction source.

The above-mentioned moving mechanism 67 is operated to advance and retract the holding table 64 in the X-axis direction. The holding table 64 can be moved to a delivering position where the holding table 64 is positioned in FIG. 4 and a peeling position which is directly under the suction pad 95 of the wafer delivery unit 90. In addition, in FIG. 4, the ultrasonic unit 78, the peeling confirmation unit 87, and the water supply unit 88 are positioned at retracted positions where they do not hinder the lifting and lowering of the suction pad 95, by the first positioning unit 70 and the second positioning unit 80.

The peeling apparatus 50 according to the present embodiment generally has the configuration described above. Now, a manner in which the wafer is peeled off from the ingot by the peeling apparatus 50 according to the present embodiment and is then delivered will be described below.

The ingot 10 having the peeling layer 40 formed therein in the above-mentioned peeling layer forming step at the depth corresponding to the wafer to be manufactured is delivered to the peeling apparatus 50 described with reference to FIG. 4. Next, the ingot 10 is placed on the suction chuck 64a of the holding table 64 at the delivering position where the holding table 64 is positioned in FIG. 4, with the substrate 20 directed downward, and the unillustrated suction means is operated to hold the ingot 10.

The holding table 64 holding the ingot 10 thereon at the delivering position is moved to a position directly under the suction pad 95 of the wafer delivery unit 90, namely, the peeling position, by operating the above-mentioned moving mechanism 67. In this instance, the suction pad 95 has been moved by the cylinder 93 to such an upper position as not to hinder movements of the ultrasonic unit 78, the peeling confirmation unit 87, and the water supply unit 88.

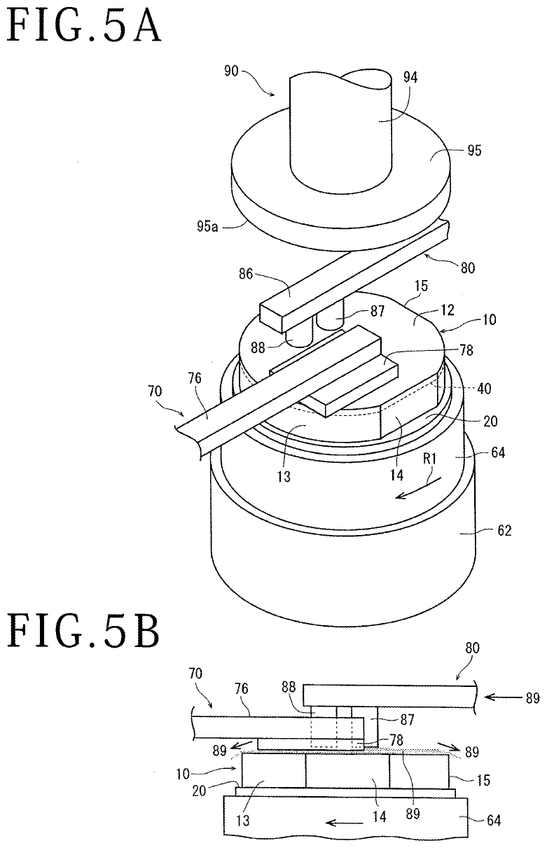

Next, the peeling confirmation unit 87 and the water supply unit 88 are moved upward to such positions that they are sufficiently away from the first end face 12 of the ingot 10 and do not make contact with the first end face 12 when the swing arm 86 is swung by the cylinder 82 of the above-mentioned second positioning unit 80. Then, the swing arm 86 is rotated to move the peeling confirmation unit 87 and the water supply unit 88 above the first end face 12 of the ingot 10, as depicted in FIG. 5A. Subsequently, the height position of the first end face 12 of the ingot 10 is detected by the unillustrated proximity sensor mounted on the above-mentioned peeling confirmation unit 87, and the lower surfaces of the peeling confirmation unit 87 and the water supply unit 88, which are set at the same height, are positioned at a predetermined height position (for example, 2 mm) from the first end face 12. Next, the swing arm 76 is rotated by the above-mentioned cylinder 72 to position the ultrasonic unit 78 above the first end face 12 of the ingot 10, as depicted in FIG. 5A. Note that the height of the first end face 12 of the ingot 10 has preliminarily been detected by the peeling confirmation unit 87 and stored in the controller 100. When the ultrasonic unit 78 is positioned above the first end face 12 by the swing arm 76 being swung, the cylinder 72 is operated to adjust the height position of the ultrasonic unit 78 on the basis of the height information stored in the controller 100, such that the height position of the lower surface 78a of the ultrasonic unit 78 from the first end face 12 of the ingot 10 is equivalent to or lower than the height positions of the above-mentioned peeling confirmation unit 87 and the water supply unit 88 (for example, 1 mm).

After the peeling confirmation unit 87, the water supply unit 88, and the ultrasonic unit 78 are positioned above the first end face 12 of the ingot 10 (see FIG. 5B) as described above, water 89 is supplied from the water supply unit 88 onto the first end face 12 of the ingot 10 at a rate of 3 L/min. The amount of the water 89 supplied in this instance is set to such an amount as to form a layer of the water 89 between the lower surface 78a of the ultrasonic unit 78 and the first end face 12 of the ingot 10 and between the lower surface of the peeling confirmation unit 87 and the first end face 12 of the ingot 10. The amount of the water 89 to be supplied is appropriately changed according to the distance between the lower surface 78a of the ultrasonic unit 78 and the first end face 12 of the ingot 10 and the distance between the lower surface of the peeling confirmation unit 87 and the first end face 12 of the ingot 10.

In the state in which the water supply unit 88 supplies a sufficient amount of water 89 and forms a layer of the water 89 as described above, the holding table 64 is rotated in the direction indicated by an arrow R1 in FIG. 5A, and an ultrasonic wave is oscillated from the lower surface 78a of the ultrasonic unit 78 to apply the ultrasonic wave to the whole region of the first end face 12 of the ingot 10. During application of the ultrasonic wave, the above-mentioned peeling confirmation unit 87 is operated to detect a variation in the height position of the first end face 12 of the ingot 10. With the above-mentioned ultrasonic wave applied to the first end face 12 of the ingot 10, the ultrasonic wave is transmitted to the first end face 12 of the ingot 10 through the water 89, causing the cracks 44 of the peeling layer 40 to extend. When the peeling-off of the wafer from the ingot 10 starting from the peeling layer 40 progresses, the height position of the first end face 12 of the ingot 10 varies upward. Here, in the present embodiment, in order to prevent the wafer to be delivered from falling off the ingot 10 and being damaged, such a peeling state that the wafer to be manufactured does not fall off the ingot 10 and can be delivered by the wafer delivery unit 90 is detected before the wafer is delivered with the first end face 12 held by the wafer delivery unit 90. More specifically, a variation in the height at the time of start of peeling (for example, set to 5 to 10 μm) which is smaller than a variation in the height at the time when the wafer is completely peeled off from the ingot 10 and falls off the ingot 10 is detected by the peeling confirmation unit 87. Note that the length of time from the start of application of the above-mentioned ultrasonic wave to the detection of the start of peeling is approximately 20 to 30 seconds.

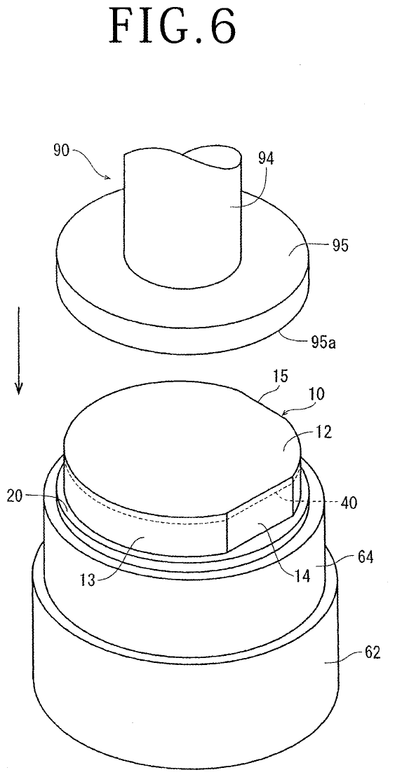

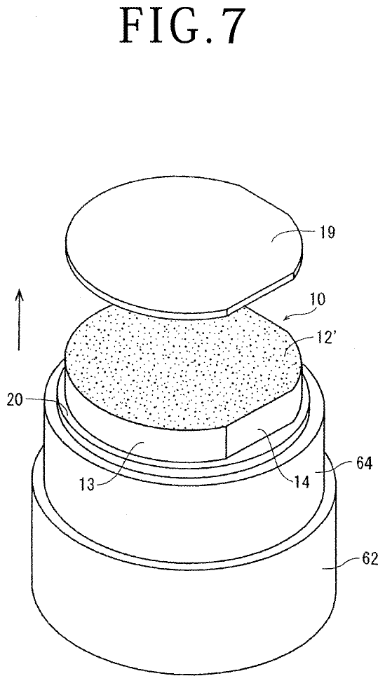

After the start of peeling starting from the peeling layer 40 is confirmed by the peeling confirmation unit 87 as described above, operations of the water supply unit 88, the ultrasonic unit 78, and the peeling confirmation unit 87 are stopped, and these units are positioned at the above-mentioned retracted positions. The retracted positions are, for example, the positions where the water supply unit 88, the ultrasonic unit 78, and the peeling confirmation unit 87 are positioned in FIG. 4 and do not hinder the lifting and lowering of the suction pad 95 of the wafer delivery unit 90. Next, as depicted in FIG. 6, the suction pad 95 of the wafer delivery unit 90 is lowered to bring the suction surface 95a of the suction pad 95 into contact with the first end face 12 of the ingot 10, and unillustrated suction means is operated to suck air through the above-mentioned suction port 96, thereby generating a negative pressure on the suction surface 95a and holding the first end face 12 of the ingot 10 under suction on the suction surface 95a. Subsequently, the suction pad 95 of the wafer delivery unit 90 is moved upward, whereby a wafer 19 whose thickness is defined by the peeling layer 40 is peeled off from the ingot 10 at the peeling layer 40 and is then delivered (the suction pad 95 of the wafer delivery unit 90 is omitted in FIG. 7 for the convenience of explanation). A new first end face 12′ of the ingot 10 from which the wafer 19 has been delivered is a rough peeling surface since it has been subjected to the above-mentioned peeling layer forming step. Therefore, before manufacturing a new wafer 19, the new first end face 12′ is polished by polishing means to be finished to a mirror surface of such an extent that the above-mentioned peeling layer forming step can be applied thereto.

The wafer 19 delivered from the ingot 10 is fed to the next step by another unillustrated delivery mechanism, or is accommodated in an unillustrated container.

According to the above-described embodiment, a timing at which the wafer to be manufactured is peeled off is appropriately detected by the peeling confirmation unit 87, whereby the wafer to be manufactured can securely be delivered from the ingot by the wafer delivery unit 90. This prevents the wafer from falling off the ingot and being damaged.

The present invention is not limited to the details of the above described preferred embodiment. The scope of the invention is defined by the appended claim and all changes and modifications as fall within the equivalence of the scope of the claim are therefore to be embraced by the invention.

What is claimed is:

1. A peeling apparatus for peeling off a wafer from an ingot having a peeling layer formed therein at a depth corresponding to the wafer to be manufactured, the peeling apparatus comprising:
a holding table that holds the ingot;
a water supply unit that forms a layer of water on an upper surface of the ingot;
an ultrasonic unit that applies an ultrasonic wave to the upper surface of the ingot through the layer of water;
a peeling confirmation unit that confirms peeling-off of the wafer to be manufactured;
a wafer delivery unit that lowers a suction pad having a suction surface facing the upper surface of the ingot, to hold the wafer to be manufactured on the suction surface under suction, and delivers the wafer from the ingot; and
a controller,
wherein after the peeling-off of the wafer is confirmed by the peeling confirmation unit, the controller positions the water supply unit, the ultrasonic unit, and the peeling confirmation unit at retracted positions and operates the wafer delivery unit to deliver the wafer from the ingot.
